(19) United States
(12) Patent Application Publication
(10) Pub. No.: US 2018/0310582 A1
(43) Pub. Date: Nov. 1, 2018

(54) METHODS FOR TREATING A DIVIDED CHEESE PRODUCT AND COMPOSITIONS THEREOF

(71) Applicant: Allied Blending LP, St. Louis, MO (US)

(72) Inventors: Ashok PATEL, Valley Park, MO (US); John FANNON, St. Louis, MO (US); Randy SCHMELZEL, Quincy, IL (US)

(21) Appl. No.: 15/963,781

(22) Filed: Apr. 26, 2018

Related U.S. Application Data
(60) Provisional application No. 62/490,394, filed on Apr. 26, 2017.

(51) Int. Cl. A23C 19/16

(52) U.S. Cl. CPC A23C 19/16; A23V 2002/00; A23V 2200/208; A23V 2250/1578; A23V 2250/16; A23V 2250/1644; A23V 2250/54252; A23V 2250/5108; A23V 2250/5118; A23V 2250/61; A23V 2250/612; A23V 2250/54246; A23V 2250/21

(57) ABSTRACT

Disclosed herein is an anticaking agent for cheese, comprising one or more dairy ingredients; and one or more non-dairy ingredients; wherein the anticaking agent can be applied to divided cheese to prevent caking. Also disclosed are food products containing an anticaking agent described herein, and methods for treating divided cheese for anticaking using an anticaking agent described herein.

This application claims the benefit of the filing date of U.S. provisional patent application No. 62/490,394 filed Apr. 26, 2017, and entitled “Methods for Treating a Divided Cheese Product and Compositions Thereof,” the entire disclosure of which is incorporated by reference in its entirety for all purposes.

The present disclosure relates to compositions used for treating divided cheese, for example to prevent sticking, clumping, or caking and compositions thereof, and related methods.

For convenience, hard and semi-hard cheeses are often sold in diced, shredded or chunked form. These divided cheeses have a propensity to clump together during storage, especially high moisture or high fat cheeses, making them difficult to handle. Anticaking agents are often added to divided cheese, to prevent sticking.

There are many anticaking compositions commercially available, including ingredients such as celluloses, starches, flours, clays, such as bentonite, metal carbonates, such as calcium carbonate, and silicon dioxide. The pre-existing anticaking additives have several drawbacks, particularly for the divided food product industry. These agents are often expensive, and may deteriorate the performance of the cheese in finished products. Additionally, these compositions generate considerable dust during packaging, and are a health hazard to workers.

Thus, there remains a need for improved methods for treating divided cheese to prevent sticking, clumping, or caking.

### SUMMARY

Accordingly, disclosed herein are anticaking products for use on divided cheese usable at higher percentage (w/w or wt.%) compared to conventional anticake treatments with no or minimal impact on flavor and textural properties, such as mouthfeel, oiling, shredding, and stringing, while inhibiting excess browning.

The present disclosure provides an anticaking agent for cheese, comprising 40-70 wt.% one or more dairy ingredients; and 30-60 wt. % one or more non-dairy ingredients; wherein the anticaking agent can be applied to divided cheese to prevent caking.

In certain embodiments, the one or more dairy ingredient is chosen from milk permeate powder, whey permeate powder, cheese whey powder, sweet dairy whey powder, non-hygroscopic dried whey, whey powder, whey protein concentrate, whey protein isolate, milk protein concentrate, milk protein isolate, whey cream, whey protein-lipid concentrate, rennet casein, calcium caseinate, sodium caseinate, milk minerals, milk calcium, milk calcium phosphate, lactose, skim milk powder, non-fat dry milk, acid casein, and combinations thereof. For example, the one or more dairy ingredient may be chosen from milk permeate powder, whey permeate powder, dried whey, and combinations thereof. In certain embodiments, the anticaking agent comprises 46-70 wt. % milk permeate powder. In certain embodiments, the anticaking agent comprises 60-70 wt. % whey permeate powder. In certain embodiments, the anticaking agent comprises 60-65 wt. % dried whey.

In certain embodiments, in the one or more non-dairy ingredient is chosen from cellulose, sugarcane fiber, calcium sulfate, calcium phosphate, dicalcium phosphate, silicon dioxide, starch, dextrose monohydrate, glucose oxidase, natamycin, potassium sorbate, mineral oil and combinations thereof. In certain embodiments, the anticaking agent comprises 30-60 wt. % one or more non-dairy ingredients. In certain embodiments, the anticaking agent comprises 5-15 wt. % calcium sulfate. In certain embodiments, the anticaking agent comprises 9.5-40 wt. % cellulose. In certain embodiments, the anticaking agent comprises 30-51 wt. % starch. In certain embodiments, the starch is corn starch or potato starch. In certain embodiments, the anticaking agent comprises 25-30.2 wt. % sugarcane fiber. In certain embodiments, the anticaking agent comprises 9.7-20 wt. % dextrose and 0.04-0.05 wt. % glucose oxidase. In certain embodiments, the anticaking agent comprises 0.06-0.08 wt. % natamycin. In certain embodiments, the anticaking agent comprises 10 wt. % potassium sorbate. In certain embodiments, the anticaking agent comprises 0.02 wt. % silica. In certain embodiments, the anticaking agent comprises 0.04-0.5 wt. % mineral oil.

In certain embodiments, the anticaking agent is chosen from Examples 1 to 9 from Table 1 or Examples 10 to 18 from Table 2.

The present disclosure further provides an anticaking agent for cheese, comprising 40-70 wt. % one or more dairy ingredients chosen from milk permeate powder, whey permeate powder, dried whey, and combinations thereof; and 30-60 wt. % one or more non-dairy ingredients chosen from cellulose, sugarcane fiber, calcium sulfate, calcium phosphate, dicalcium phosphate, silicon dioxide, starch, dextrose monohydrate, glucose oxidase, natamycin, potassium sorbate, mineral oil and combinations thereof; wherein the anticaking agent can be applied to divided cheese to prevent caking.

The present disclosure also provides a food product comprising: divided cheese comprising a plurality of individual cheese particles; and an anticaking agent disclosed herein dispersed on the individual cheese particles in an amount sufficient to inhibit caking of the individual cheese particles. In certain embodiments, the anticaking agent is applied at up to 6 wt. % of the product.

Also provided is a method of treating divided cheese for anticaking, comprising: providing divided cheese; dispersing an anticaking agent described herein over the divided cheese; wherein the anticaking agent provides a means for controlling the cheese browning during cooking. In certain embodiments, the anticaking agent is applied at up to 6 wt. % of the food product.

### DETAILED DESCRIPTION

To aid understanding of the disclosure, several terms and abbreviations as used herein are defined below as follows:

The articles “a”, “an”, “the” and “said” are intended to mean that there are one or more of the elements. The terms “comprising”, “including” and “having” are intended to be inclusive and mean that there may be additional elements other than the listed elements.

The term “and/or” when used in a list of two or more items, means that any one of the listed items can be employed by itself or in combination with any one or more of the listed items. For example, the expression “A and/or B” is intended to mean either or both of A and B, i.e. A alone, B alone or A and B in combination. The expression “A, B and/or C” is intended to mean A alone, B alone, C alone, A and B in combination, A and C in combination, B and C in combination or A, B, and C in combination.

Anticaking agent in the food industry, especially in the dairy and cheese industry, is defined as any safe and suitable food ingredient which, when added, should prevent lumping of shredded, diced or chunked dairy product, such as cheese, during storage at room temperature or refrigerator or freezer. Such a dairy product with anticaking agent in it should be easy to handle at the time of applying on the final food product. Some cheeses, after they are chunked and if the anticaking agent is not used, will cake and are very difficult to handle. This is a serious problem especially with high moisture and high fat cheeses. Several anticaking agents are commercially available, such as cellulose, microcrystalline cellulose, and starch.

The term “cheese” as used herein refers broadly to all types of cheeses including, for example, cheeses as defined under the CODEX general Standard for Cheese and as defined under various state and national regulatory bodies. Exemplary classes of cheeses include, but are not limited to, firm/semi-hard cheeses, soft cheeses, analog cheeses, blended cheeses, and pasta filata cheeses, among other types of cheeses.

The present disclosure provides an anticaking agent for cheese, comprising 40-85 wt. % one or more dairy ingredients; and 15-60 wt. % one or more non-dairy ingredients; wherein the anticaking agent can be applied to divided cheese to prevent caking. In certain embodiments, the anticaking agent for cheese comprises 40-70 wt. % one or more dairy ingredients; and 30-60 wt. % one or more non-dairy ingredients; wherein the anticaking agent can be applied to divided cheese to prevent caking.

The term “dairy ingredient” as used herein refers to products or byproducts obtained from processing milk. In certain embodiments, the dairy ingredients consist essentially of one or more constituents of milk, namely, milk proteins, milk fat, lactose and/or milk minerals. In various embodiments, the dairy ingredient is chosen from milk permeate powder, whey permeate powder, cheese whey powder, sweet dairy whey powder, non-hygroscopic dried whey, acid whey powder, whey protein concentrate, whey protein isolate, milk protein concentrate, milk protein isolate, whey cream, whey protein-lipid concentrate, rennet casein, calcium caseinate, sodium caseinate, milk minerals, milk calcium, milk calcium phosphate, lactose, skim milk powder, non-fat dry milk, acid casein, and combinations thereof. For example, the one or more dairy ingredient may be chosen from milk permeate powder, whey permeate powder, dried whey, and combinations thereof.

In certain embodiments, the anticaking agent comprises 43-75 wt. % milk permeate powder, such as between 46 wt. % and 70 wt. % milk permeate powder, for example between 43 wt. % and 45 wt. %, between 45 wt. % and 50 wt. %, between 50 wt. % and 55 wt. %, between 55 wt. % and 60 wt. %, between 60 wt. % and 65 wt. %, between 65 wt. % and 70 wt. %, or between 70 wt. % and 75 wt. % milk permeate powder. In certain embodiments, the anticaking agent comprises more than 43 wt. % milk permeate powder, such as more that 46 wt. % milk permeate powder. In certain embodiments, the anticaking agent comprises less than 75 wt. % milk permeate powder, such as less than 70 wt. %.

In certain embodiments, the anticaking agent comprises 60-70 wt. % whey permeate powder, such as between 60 wt. % and 65 wt. %, or between 65 wt. % and 70 wt. % whey permeate powder. In certain embodiments, the anticaking agent comprises 25 wt. %, 60 wt. %, or 69.8 wt. % whey permeate powder. In certain embodiments, the anticaking agent comprises more than 60 wt. % whey permeate powder. In certain embodiments, the anticaking agent comprises less than 70 wt. % whey permeate powder.

In certain embodiments, the anticaking agent comprises 60-65 wt. % dried whey, such as 60 wt. %, 61 wt. %, 62 wt. %, 63 wt. %, 64 wt. %, or 65 wt. % dried whey. In certain embodiments, the anticaking agent comprises more than 60 wt. % dried whey. In certain embodiments, the anticaking agent comprises less than 65 wt. % dried whey.

In certain embodiments, the anticaking agent comprises 10 wt. % milk minerals.

The term “non-dairy ingredient” as used herein refers to ingredients essentially free from milk components. In various embodiments, the non-dairy ingredient is chosen from cellulose, modified cellulose, calcium sulfate, calcium phosphate, dicalcium phosphate, silicon dioxide, native starch, modified starch, bentonite, and combinations thereof. In certain embodiments, in the one or more non-dairy ingredient is chosen from cellulose, sugarcane fiber, calcium sulfate, calcium phosphate, dicalcium phosphate, silicon dioxide, starch, dextrose monohydrate, glucose oxidase, natamycin, potassium sorbate, mineral oil and combinations thereof.

In certain embodiments, the anticaking agent comprises 30-60 wt. % one or more non-dairy ingredients, such as between 30 wt. % and 35 wt. %, between 35 wt. % and 40 wt. %, between 40 wt. % and 45 wt. %, between 45 wt. % and 50 wt. %, between 50 wt. % and 55 wt. %, or between 55 wt. % and 60 wt. % one or more non-dairy ingredients. In certain embodiments, the anticaking agent comprises more than 30 wt. % one or more non-dairy ingredients. In certain embodiments, the anticaking agent comprises less than 60 wt. % one or more non-dairy ingredients.

In certain embodiments, the anticaking agent comprises 5-15 wt. % calcium sulfate, such as 5 wt. %, 6 wt. %, 7 wt. %, 8 wt. %, 9 wt. %, 10 wt. %, 11 wt. %, 12 wt. %, 13 wt. %, 14 wt. %, or 15 wt. %. In certain embodiments, the anticaking agent comprises 10 wt. % calcium sulfate. In certain embodiments, the anticaking agent comprises more than 5 wt. % calcium sulfate. In certain embodiments, the anticaking agent comprises less than 15 wt. % calcium sulfate.

In certain embodiments, the anticaking agent comprises 9.5-40 wt. % cellulose, such as between 9.5 wt. % and 10 wt. %, between 10 wt. % and 15 wt. %, between 15 wt. % and 20 wt. %, between 20 wt. % and 25 wt. %, between 25 wt. % and 30 wt. %, between 30 wt. % and 35 wt. %, or between 35 wt. % and 40 wt. % cellulose. In certain embodiments, the anticaking agent comprises more than 9.5 wt. % cellulose. In certain embodiments, the anticaking agent comprises less than 40 wt. % cellulose.

In certain embodiments, the anticaking agent comprises 30-51 wt. % starch, such as between 30 wt. % and 35 wt. %, between 35 wt. % and 40 wt. %, between 40 wt. % and 45 wt. %, between 45 wt. % and 50 wt. %, between 50 wt. % and 51 wt. % starch. In certain embodiments, the anticaking agent comprises more than 30 wt. % starch. In certain embodiments, the anticaking agent comprises less than 51 wt. % starch.

As used herein the term “starch” refers to any material comprising the complex polysaccharide carbohydrates of plants, comprising amylose and amylopectin with the formula (C₆H₁₀O₅)ₓ, wherein x can be any number. In various embodiments, the starches used herein are native starches and/or are starches that have been modified by cross-linking, derivatization, substitution, or other processes that involve chemical treatment to impart desired functional properties. In certain embodiments, the modified starches are cross-linked starches, which may comprise a native starch that has been cross-linked via any suitable cross-linking technique known in the art or otherwise found to be suitable in conjunction with the disclosed compositions. In a specific embodiment, the modified starch is distarch phosphate with and without substitution using any type of native starch or acid or enzyme modified starches with or without cross-linking and/or substitution.

Suitable examples of native starch include, but are not limited to, cereal starch, potato starch and legume starch, such as Irish potato starch, sweet potato starch, tapioca starch, cornstarch, rice starch, wheat starch, sorghum starch and the like; typical examples of starch derivatives are dextrin, cross-linked starch and the like. Regardless of the starch-containing material from which the starch and its derivatives are derived, and the form of the starch (e.g. a straight-chain starch or a branched starch), D-glucose bonded with α-1,4-glucoside or α-1,6-glucoside linkage constitutes the fundamental structure, and thus starch and its derivatives either those described above or those not mentioned here may be applicable.

In various embodiments, the starch is chosen from corn starch, potato starch, wheat starch, rice starch, sago starch, tapioca starch, and sorghum starch. In certain embodiments, the starch is corn starch. In certain embodiments, the starch is potato starch.

In certain embodiments, the anticaking agent comprises 25-30.2 wt. % sugarcane fiber, such as 25 wt. %, 26 wt. %, 27 wt. %, 28 wt. %, 29 wt. %, 30 wt. %, 30.1 wt. %, or 30.2 wt. % sugarcane fiber. In certain embodiments, the anticaking agent comprises more than 25 wt. % sugarcane fiber. In certain embodiments, the anticaking agent comprises less than 30.2 wt. % sugarcane fiber.

When present, the combination of dextrose and glucose oxidase enzyme is an oxygen scavenger system that can be added to any anticaking agent described herein, for example to preserve freshness. In certain embodiments, the anticaking agent comprises 9.7-20 wt. % dextrose and 0.04-0.05 wt. % glucose oxidase, such at 9.7 wt. %, 10 wt. %, 11 wt. %, 12 wt. %, 13 wt. %, 14 wt. %, 15 wt. %, 16 wt. %, 17 wt. %, 18 wt. %, 19 wt. %, or 20 wt. % dextrose in combination with 0.04 wt. % or 0.05 wt. % glucose oxidase. The dextrose may be in a hydrated crystalline form, such as dextrose monohydrate. In certain embodiments, the anticaking agent comprises more than 9.7 wt. % dextrose. In certain embodiments, the anticaking agent comprises less than 20 wt. % dextrose. In certain embodiments, the anticaking agent comprises more than 0.04 wt. % glucose oxidase. In certain embodiments, the anticaking agent comprises less than 0.05 wt. % glucose oxidase.

In certain embodiments, the anticaking agent comprises an antimycotic, such as natamycin. In certain embodiments, the anticaking agent comprises 0.06-0.08 wt. % natamycin, such as 0.06 wt. %, 0.07 wt. %, or 0.08 wt. % natamycin. In certain embodiments, the anticaking agent comprises more than 0.06 wt. % natamycin. In certain embodiments, the anticaking agent comprises less than 0.08 wt. % natamycin.

In certain embodiments, the anticaking agent comprises 10 wt. % potassium sorbate.

In certain embodiments, the anticaking agent comprises 0.02 wt. % silica. The silica may be Sipernat™ by Evonik, such as Sipernat™ 22LS.

In certain embodiments, the anticaking agent comprises 0.04-0.5 wt. % mineral oil, such as 0.04 wt. %, between 0.05 wt. % and 0.1 wt. %, between 0.1 wt. % and 0.15 wt. %, between 0.15 wt. % and 0.2 wt. %, between 0.2 wt. % and 0.25 wt. %, between 0.25 wt. % and 0.3 wt. %, between 0.3 wt. % and 0.35 wt. %, between 0.35 wt. % and 0.4 wt. %, between 0.4 wt. % and 0.45 wt. %, or between 0.45 wt. % and 0.5 wt. % mineral oil. In certain embodiments, the anticaking agent comprises more than 0.05 wt. % mineral oil. In certain embodiments, the anticaking agent comprises less than 0.5 wt. % mineral oil.

In certain embodiments, the anticaking agent is essentially free of clays, such as bentonite. In certain embodiments, the anticaking agent is essentially free of metal carbonates, such as calcium carbonate. In certain embodiments, the anticaking agent is essentially free of silicon dioxide. In certain embodiments, the anticaking agent is essentially free of cellulose. In certain embodiments, the anticaking agent is essentially free of cellulose and metal carbonates.

The present disclosure also provides a food product comprising: divided cheese comprising a plurality of individual cheese particles; and an anticaking agent disclosed herein dispersed on the individual cheese particles in an amount sufficient to inhibit caking of the individual cheese particles. In certain embodiments, the anticaking agent is applied at up to 6 wt. % of the product.

In various embodiments, the anticaking agent is applied to divided cheese at about 1 wt. %. In various embodiments, the anticaking agent is applied to divided cheese at about 2 wt. %. In various embodiments, the anticaking agent is applied to divided cheese at about 3 wt. %. In various embodiments, the anticaking agent is applied to divided cheese at about 4 wt. %. In various embodiments, the anticaking agent is applied to divided cheese at about 5 wt. %. In various embodiments, the anticaking agent is applied to divided cheese at about 6 wt. %. In various embodiments, the anticaking agent is applied to divided cheese at about 7 wt. %.

### Methods

In various embodiments, there is provided is a method of treating divided cheese for anticaking, comprising: providing divided cheese; dispersing an anticaking agent described herein over the divided cheese; wherein the anticaking agent provides a means for controlling the cheese browning during cooking. In certain embodiments, the anticaking agent is applied at up to 6 wt. % of the food product.

After reading this description, it will become apparent to one skilled in the art how to implement the disclosure in various alternative embodiments and alternative applications. However, although various embodiments of the present disclosure will be described herein, it is understood that these embodiments are presented by way of example only, and not limitation. As such, this detailed description of various alternative embodiments should not be construed to limit the scope or breadth of the present disclosure as set forth in the appended claims.

### EXAMPLES

### Compositions

Tables 1 and 2 illustrate formulations for anticaking compositions that have been prepared and tested.

TABLE 1

| | Example (wt. %) | | | | | | | | |
|---|---|---|---|---|---|---|---|---|---|
| Ingredient | 1 | 2 | 3 | 4 | 5 | 6 | 7 | 8 | 9 |
| Milk permeate | 60 | — | 70 | 55.8 | — | — | 60 | — | — |
| powder | | | | | | | | | |
| Whey permeate | — | 60 | — | — | 35 | 60 | — | — | 25 |
| powder | | | | | | | | | |
| Dried whey | — | — | — | — | — | — | — | 60 | — |
| Milk minerals | — | — | — | — | 20 | — | — | — | — |
| Lactose | — | — | — | — | 35 | — | — | — | — |
| Casein | — | — | — | — | 10 | — | — | — | — |
| Calcium sulfate | 10 | 10 | — | — | — | — | — | 10 | — |
| Cellulose | 30 | 30 | 30 | — | — | 40 | 10 | 30 | 20 |
| Potato starch | — | — | — | 43.6 | — | — | — | — | — |
| Corn starch | — | — | — | — | — | — | 30 | — | 55 |
| Natamycin | — | — | — | 0.08 | — | — | — | — | — |
| Mineral Oil | — | — | — | 0.5 | — | — | — | — | — |
| Total | 100 | 100 | 100 | 100 | 100 | 100 | 100 | 100 | 100 |

TABLE 2

| | Example (wt. %) | | | | | | | | |
|---|---|---|---|---|---|---|---|---|---|
| Ingredient | 10 | 11 | 12 | 13 | 14 | 15 | 16 | 17 | 18 |
| Milk permeate | 50.5 | 59.7 | 49.4 | 51.2 | 49.2 | — | 45.9 | 50.2 | — |
| powder | | | | | | | | | |
| Whey permeate | — | — | — | — | — | — | — | — | 69.7 |
| powder | | | | | | | | | |
| Dried whey | — | — | — | — | — | 64.6 | — | — | — |
| Calcium sulfate | 10.5 | — | — | — | — | — | — | — | — |
| Cellulose | 29.2 | — | — | 9.5 | — | — | — | — | — |
| Sugarcane fiber | — | 30.1 | — | — | — | 25.1 | — | — | 30.2 |
| Potato starch | — | — | 50.1 | 38.7 | 30.0 | — | — | — | — |
| Corn starch | — | — | — | — | — | — | 43.9 | 49.4 | — |
| Dextrose | 9.7 | 10.1 | — | — | 20.0 | — | 10.0 | — | — |
| monohydrate | | | | | | | | | |
| Glucose oxidase | 0.04 | 0.04 | — | — | 0.05 | — | 0.05 | — | — |
| Natamycin | 0.08 | 0.07 | 0.08 | 0.08 | 0.06 | — | 0.08 | 0.08 | — |
| Potassium | — | — | — | — | — | 10.0 | — | — | — |
| sorbate | | | | | | | | | |
| Sipernat ™ | — | — | — | 0.02 | — | — | — | — | — |
| 22LS | | | | | | | | | |
| Mineral oil | 0.04 | 0.05 | 0.40 | 0.50 | 0.50 | 0.31 | 0.12 | 0.30 | 0.06 |
| Total | 100.0 | 100.0 | 100.0 | 100.0 | 100.0 | 100.0 | 100.0 | 100.0 | 100.0 |

Sipernat ™ 22LS is a silica with spherical particles, low fines content and high oil absorption (DBP) supplied by Evonik Industries. Sipernat ™ combines high absorption capacity for liquids with high bulk density and very good flow properties.

### Anticaking Properties

The properties of the anticaking compositions were studied via a series of iterative pizza cheese bake tests. Each bake test contained a control sample—cellulose added to shredded cheese at 1.5 wt., and experimental samples—anticaking blends at 4.0 wt. %. Results from each test were used to improve ingredient blends for subsequent tests. Visual examination of anticaking effectiveness was determined 1-2 days following addition to the shredded cheese. Anticaking blends that resulted in pizza cheese shreds sticking or lumping may be excluded from the bake tests. The treated cheeses were evaluated in tests using the following guidelines shown in Table 3.

Cheese were prepared with the anticaking compositions as follows:
1. Shred cheese using the Kitchen Aid™ stand mixer (speed setting 2) with the attached coarse shredder. Target average shred size: length—45 mm, width—3-4 mm.
2. Weigh desired quantity of cheese.
3. Place cheese into a 60-ounce plastic container and add anticaking agent, either 1.5 wt. % cellulose powder or 4 wt. % experimental anticaking blend (pre-mixed).
4. Put a lid on the container and shake the container by hand until anticaking agent is incorporated into the shredded cheese (approximately 15 seconds).
5. Hold the shredded cheese with anticaking ingredients in the 60-ounce containers at 40° F. for 20-60 hours.
6. For pizza cheese bake evaluation, follow the Pizza Preparation and Evaluation procedure.

Pizza was prepared and evaluated using the following methods:
1. Preheat Impinger Oven to 450° F. Set the bake time for 4 minutes and 30 seconds.
2. Remove up to 4 sets of shredded cheese with anticaking ingredient from cooler and up to 4 pizza crusts from a freezer. Place on counter at room temperature.
3. Place 130 g pizza sauce on a 12″ pizza crust and spread uniformly to within about 1″ of the edge. Uniformly distribute 200 grams of cheese with anticaking agent onto the pizza.
4. Place the pizza on a round pizza screen. Then, place the screen on the conveyor belt and bake the pizza. Do not push pizza into oven; allow the belt to pull the pizza into the Impinger Oven.
5. While cooling, evaluate pizza for browning, oiling off and shred using the Pizza Cheese Evaluation Guidelines (Table 3).
6. After 2 minutes, test string by inserting a fork under the cheese and pulling in an upward motion and noting the height with a ruler at which the cheese breaks.
7. Evaluate flavor, mouth feel and appearance at 10 minutes.
8. Evaluate pizza cheese appearance after 30 minutes and 60 minutes. Record any observations.

TABLE 3
Pizza Cheese Evaluation Guidelines

| 1 | | Browning |
|---|---|---|
| | 10 | No or very few small brown spots |
| | 8 | Small brown spots about the size of a dime (1.8 cm diameter) |
| | 4 | 50% brown spots on the surface—some large, some small |
| | 1 | 95-100% covered with large (quarter-sized, 2.4 cm diameter) |
| | | brown spots on the surface |
| 2 | | Oiling |
| | 10 | Slight oil sheen visible |
| | 8 | Very few pools present, smaller than a dime (1.8 cm) |
| | 4 | Slight pools present, larger than a dime (1.8 cm) |
| | 1 | Many large pools present |
| 4 | | Shred |
| | 10 | Confluent—melting all together |
| | 8 | Outline of shred still evident—10% |
| | 5 | Outline of shreds still evident—30% |
| | 1 | Little to no sign of melting |
| 5 | | String—a 2 minutes until breakage |
| | | Noted as the actual length of string when lifted with fork. |
| 6 | | Flavor |
| | 10 | Good flavor—no off tastes |
| | 5 | Some off notes on flavor |
| | 1 | Unacceptable flavor |
| 7 | | Mouthfeel |
| | 10 | Smooth tender body |
| | 8 | Mostly soft or slightly chewy, but smooth |
| | 4 | Moderately tough or chewy, mealy, grainy plastic mouthfeel |
| | 1 | Extremely tough, excessive graininess, sandiness and/or |
| | | chewiness |
| 8 | | Appearance at 10 minutes |
| | 10 | White or slight off-white |
| | 8 | Slightly translucent |
| | 4 | Moderately translucent |
| | 1 | Very translucent |

What is claimed is:

1. An anticaking agent for cheese, comprising
40-70 wt. % one or more dairy ingredients; and
30-60 wt. % one or more non-dairy ingredients;
wherein the anticaking agent can be applied to divided cheese to prevent caking.

2. The anticaking agent of claim 1, wherein the one or more dairy ingredient is chosen from milk permeate powder, whey permeate powder, cheese whey powder, sweet dairy whey powder, non-hygroscopic dried whey, whey powder, whey protein concentrate, whey protein isolate, milk protein concentrate, milk protein isolate, whey cream, whey protein-lipid concentrate, rennet casein, calcium caseinate, sodium caseinate, milk minerals, milk calcium, milk calcium phosphate, lactose, skim milk powder, non-fat dry milk, acid casein, and combinations thereof.

3. The anticaking agent of claim 2, wherein the one or more dairy ingredient is chosen from milk permeate powder, whey permeate powder, whey powder, and combinations thereof.

4. The anticaking agent of claim 3, comprising 46-70 wt. % milk permeate powder.

5. The anticaking agent of claim 3, comprising 60-70 wt. % whey permeate powder.

6. The anticaking agent of claim 3, comprising 60-65 wt. % dried whey.

7. The anticaking agent of claim 1, wherein the one or more non-dairy ingredient is chosen from cellulose, sugarcane fiber, calcium sulfate, calcium phosphate, dicalcium phosphate, silicon dioxide, starch, dextrose monohydrate, glucose oxidase, natamycin, potassium sorbate, mineral oil and combinations thereof.

8. The anticaking agent of claim 7, comprising 5-15 wt. % calcium sulfate.

9. The anticaking agent of claim 7, comprising 9.5-40 wt. % cellulose.

10. The anticaking agent of claim 7, comprising 30-51 wt. % starch.

11. The anticaking agent of claim 10, wherein the starch is corn starch or potato starch.

12. The anticaking agent of claim 9, comprising 25-30.2 wt. % sugarcane fiber.

13. The anticaking agent of claim 9, comprising 9.7-20 wt. % dextrose and 0.04-0.05 wt. % glucose oxidase.

14. The anticaking agent of claim 9, comprising 0.06-0.08 wt. % natamycin.

15. The anticaking agent of claim 9, comprising 10 wt. % potassium sorbate.

16. The anticaking agent of claim 9, comprising 0.02 wt. % silica.

17. The anticaking agent of claim 9, comprising 0.04-0.5 wt. % mineral oil.

18. An anticaking agent for cheese, comprising
40-70 wt. % one or more dairy ingredients chosen from milk permeate powder, whey permeate powder, dried whey, and combinations thereof; and
30-60 wt. % one or more non-dairy ingredients chosen from cellulose, sugarcane fiber, calcium sulfate, calcium phosphate, dicalcium phosphate, silicon dioxide, starch, dextrose monohydrate, glucose oxidase, natamycin, potassium sorbate, mineral oil and combinations thereof;
wherein the anticaking agent can be applied to divided cheese to prevent caking.

19. The anticaking agent of claim 18, comprising 9.5-40 wt. % cellulose.

20. The anticaking agent of claim 18, comprising 30-51 wt. % starch.

21. The anticaking agent of claim 20, wherein the starch is corn starch or potato starch.

22. An anticaking agent chosen from Examples 1 to 9 from Table 1 or Examples 10 to 18 from Table 2.

23. A food product comprising:
a. divided cheese comprising a plurality of individual cheese particles; and
b. an anticaking agent of claim 1 dispersed on the individual cheese particles in an amount sufficient to inhibit caking of the individual cheese particles.

24. The food product of claim 23, wherein said anticaking agent is applied at up to 6 wt. % of the product.

25. A method of treating divided cheese for anticaking, comprising:
a. providing divided cheese;
b. dispersing the anticaking agent of claim 1 over the divided cheese;
wherein the agent provides a means for controlling the cheese browning during cooking.

26. The method of claim 25, wherein said anticaking agent is applied at up to 6 wt. % of the food product.
